(19) United States
(12) Patent Application Publication
(10) Pub. No.: US 2009/0300964 A1
(43) Pub. Date: Dec. 10, 2009

(54) Variable Depth Fishing Lure and associated methods

(76) Inventor: Peter P. Nemethy, Treasure Island, FL (US)

Correspondence Address: JACQUELINE E. HARTT, PH.D;Allen Dyer Doppelt Milbrath & Gilchrist, P.A., 255 S. Orange Ave., Suite 1401, P.O. Box 3791, ORLANDO, FL, 32801-3791, US

(21) Appl. No.: 12/025,956

(22) Filed: Feb. 5, 2008

(51) Int. Cl. A01K 85/00; A01K 99/00

(52) U.S. Cl. 43/4.5; 43/42.22; 43/42.53

(57) ABSTRACT

A variable-depth fishing lure includes an elongated lure body and a depth-control lip body at a front end. The lip body has opposed sides and an arcuate forward portion meeting the sides at outwardly extending shoulders. The forward portion has a beveled edge therearound. A lip extension is removably affixable to the lip body and has an arcuate inner edge dimensioned for sliding onto the lip body's forward portion. The inner edge has a slot therein configured to be slidable over the lip body's beveled forward edge. The lip extension has an arcuate front edge and opposed back ends positioned in bridging relation between the front and the inner edges. The back ends are dimensioned to substantially coincide with the lip body shoulders. The front edge meets the lip body's forward portion edge to form a substantially continuous side edge.

### FIELD OF INVENTION

The present invention generally relates to implements for fishing, and, in particular, to fishing lures and methods construction and use.

### BACKGROUND

Fishermen in particular types of fishing are known to use lures, which are attached to the end of a fishing line and are often designed to resemble and move like a creature that can serve as prey to the fish being sought. Lures, which are tied to the fishing line, typically have attached thereto one or more hooks that enter and affix to the fish's mouth when the fish attempts to eat the lure.

In some types of fishing, the lure is repetitively cast out and reeled back in by the fisherman. Since each type of fish has a preferred depth range in which to reside, it is known in the art to provide lures with lips, or bills, at their front ends that can control the depth to which the lure sinks when cast out, and thus the depth in which the lure travels during retrieval.

Fishermen often carry a plurality of lure types that can be selected depending upon the environmental conditions and the fish being sought. Since it is time-consuming and difficult to remove one lure and tie another onto the fishing line, it is known in the art to provide lures with interchangeable lips so that the same lure body can remain on the fishing line and serve at variable depths.

However, the lips of those variable-depth fishing lures known in the art are cumbersome to exchange, and thus have not found widespread commercial acceptance and success.

Therefore, it would be beneficial to provide a variable-depth fishing lure having readily interchangeable lips.

### SUMMARY OF THE INVENTION

The present invention is directed to a variable-depth fishing lure that comprises an elongated lure body. A depth-control lip body extends from a front end of the lure body. The lip body has opposed sides that are substantially parallel to opposed sides of the lure body. The lip body further has an arcuate forward portion that meets the opposed sides at outwardly extending shoulders. The forward portion has a beveled edge at least partially therearound.

A lip extension is removably affixable to the lip body. The lip body has an arcuate inner edge that is dimensioned for sliding onto and being retained by the lip body's forward portion. The inner edge has a slot therein at least partially therearound, configured so that the slotted inner edge is slidable over the lip body's beveled forward edge and retainable thereon.

The lip extension has an arcuate front edge and opposed back ends that are positioned in bridging relation between the front and the inner edges. The back ends are dimensioned to substantially coincide with the lip body shoulders. The front edge meets the lip body's forward portion edge to form a substantially continuous side edge.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWING

FIG. 1 is a top plan view of the fishing lure and detachable lip extension.

FIG. 2 is a side perspective view of the fishing lure and lip extension of FIG. 1.

FIG. 3 is a bottom plan view of the lip body and lip extension of FIG. 1.

FIG. 4 is a bottom plan view of an alternate embodiment of the lip body and lip extension.

FIG. 5 is a lateral cross-sectional view of the lip extension of FIG. 4 along line 5-5′.

FIG. 6 is a rear view of the lip body of FIG. 4.

### DETAILED DESCRIPTION OF THE PREFERRED EMBODIMENT

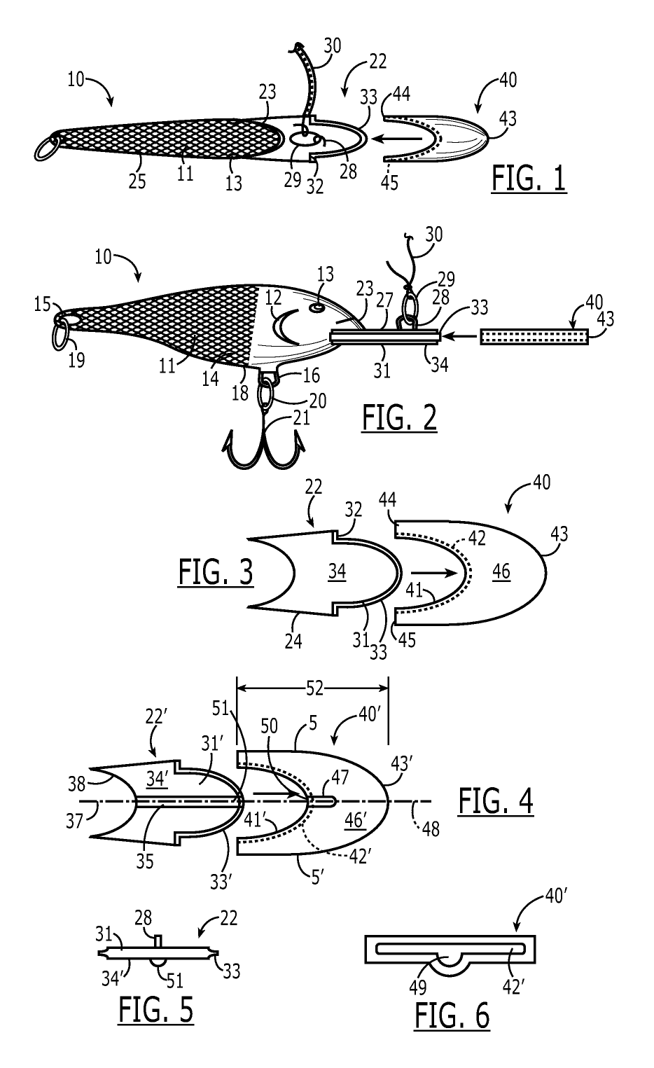

A description of the preferred embodiments of the present invention will now be presented with reference to FIGS. 1-6.

As discussed above, the present invention is directed in one aspect to a variable-depth fishing lure 10 that comprises an elongated lure body 11 (FIGS. 1 and 2). The lure body 11 can have a shape and appearance that is designed to resemble a bait fish of a fish desired to be caught, although such details are not intended to be limiting. The shape can be that of a small fish, for example, and the appearance can include a color chosen to be similar to that of the bait fish, simulated gills 12, eyes 13, and scales 14, for example, as will be readily understood by one of skill in the art.

The lure body 11 can further comprise at least one attachment element affixed thereto for attaching fish hooks thereto. In FIGS. 1 and 2 is illustrated a lure body 11 having two eyes 15,16, one 15 at the back end 17 and one 16 along the bottom surface 18. To each of these eyes 15,16 is affixed a second attachment element 19,20, here rings, to which can be affixed one or more fish hooks 21.

A depth-control lip body 22 extends from a front end 23 of the lure body 11, and can be affixed thereto or formed integrally therewith as a matter of design and production choice. The lip body 22 has opposed sides 24 that are substantially parallel to and continuous with opposed sides 25 of the lure body 11.

Affixed to a top surface 27 is an attachment element, here, another eye 28 and ring 29 assembly, for affixing a fishing line 30 thereto. The lip body 22 further has an arcuate forward portion 31 that meets the opposed sides 24 at outwardly extending shoulders 32. The forward portion 31 has a beveled edge 33 at least partially therearound.

In one embodiment (FIGS. 2 and 3), the lip body 22 has a substantially planar bottom surface 34.

In an alternate embodiment (FIG. 4), the lip body 22′ has a longitudinal ridge 35 protruding from the bottom surface 34′. The ridge 35 in this embodiment extends along a longitudinal axis 37 from a rear edge 38 adjacent the lure body 11 to a region of the forward portion 31′ that is approximately at a center of the beveled edge 33′.

A lip extension 40 is removably affixable to the lip body 11. The lip extension 40 has an arcuate inner edge 41 that is dimensioned for sliding onto and being retained by the lip body's forward portion 31,31′ (FIGS. 4,5). The inner edge 41 has a slot 42,42′ therein at least partially therearound that is configured so that the slotted inner edge 41 is slidable over the lip body's beveled forward edge 33 and retainable thereon.

The lip extension 40 further has an arcuate front edge 43 and opposed back ends 44,45 that are positioned in bridging relation between the front 43 and the inner 41 edges. The back ends 44,45 are dimensioned to substantially coincide with the lip body's shoulders 32. The front edge 43 meets the lip body's forward portion edge 33 to form a substantially continuous side edge.

In the alternate embodiment of FIG. 4, the lip extension 40′ can have a longitudinal ridge 47 that protrudes from the bottom face 46′. The ridge 47 extends along a longitudinal axis 48′ from a center of the inner edge 41′ to a region in spaced relation from the front edge 43′. In this embodiment, the lip extension's longitudinal ridge 47 further has an aperture 49 that extends from a back end 50 and is in communication with the slot 42′. The aperture 49 is dimensioned and configured for receiving a front portion 51 of the lip body's ridge 35 thereinto.

Preferably, more than one lip extension 40,40′ is provided, for example, in a kit that can include a plurality of lip extensions 40,40′ with one or more lure bodies 11. The lip extensions 40,40′ can have one or more lengths 52 along their longitudinal axes 48,48′ for achieving different water depths when in use.

Although not intended as a limitation on the invention, in a particular embodiment the lip body 11 and the lip extension 40,40′ can comprise a moldable plastic material, with the lip body 11 harder than the lip extension 40,40′, so that sliding the lip extension one and off is easier and a press fit is facilitated therebetween.

A method of using the fishing lure 10 of the present invention includes affixing the fishing lure 10 to a fishing line 30 and casting the fishing lure 10 into a body of water. The fishing lure 10 is reeled in, with the lip extension 40 controlling a depth of the lure 10. The lip extension 40 can be removed if desired to achieve a different depth and replaced with a second lip extension 40′, and the process repeated.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the device illustrated and described herein are by way of example, and the scope of the invention is not limited to the exact details of construction or use.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A variable-depth fishing lure comprising:
an elongated lure body;
a depth-control lip body extending from a front end of the lure body, the lip body having:
opposed sides substantially parallel to opposed sides of the lure body; and
an arcuate forward portion meeting the opposed sides at outwardly extending shoulders, the forward portion having a beveled edge at least partially therearound; and
a lip extension removably affixable to the lip body and having:
an arcuate inner edge dimensioned for sliding onto and being retained by the lip body forward portion, the inner edge having a slot therein at least partially therearound, the slotted inner edge slidable over the lip body beveled forward edge;
an arcuate front edge; and
opposed back ends in bridging relation between the front and the inner edges, the back ends dimensioned to substantially coincide with the lip body shoulders, the front edge meeting the lip body forward portion edge to form a substantially continuous side edge.

2. The variable-depth fishing lure recited in claim 1, wherein the lure body comprises at least one attachment element affixed thereto for attaching fish hooks thereto.

3. The variable-depth fishing lure recited in claim 1, wherein the lure body has a shape designed to resemble a bait fish of a fish desired to be caught.

4. The variable-depth fishing lure recited in claim 1, wherein the lip body further has an attachment element affixed thereto for attaching a fishing line thereto.

5. The variable-depth fishing lure recited in claim 1, wherein the lip body has a bottom surface that is substantially planar.

6. The variable-depth fishing lure recited in claim 1, wherein the lip body has a longitudinal ridge protruding from a bottom surface, the ridge extending along a longitudinal axis from a rear edge adjacent the lure body to a region of the forward portion that is approximately at a center of the beveled edge.

7. The variable-depth fishing lure recited in claim 6, wherein the lip extension further has a longitudinal ridge protruding from a bottom face, the ridge extending along a longitudinal axis from a center of the inner edge to a region in spaced relation from the front edge.

8. The variable-depth fishing lure recited in claim 7, wherein the lip extension longitudinal ridge further has an aperture extending from a back end and in communication with the slot, the aperture dimensioned and configured for receiving a front portion of the lip body ridge thereinto.

9. The variable-depth fishing lure recited in claim 1, wherein the lip extension comprises a first lip extension having a first length along a longitudinal axis thereof, and further comprising a second lip extension removably affixable to the lip body, interchangeable with the first lip extension for achieving a second water depth different from a first water depth achievable by the first lip extension, and having a second length along a longitudinal axis thereof, the second lip extension having:
an arcuate inner edge dimensioned for sliding onto and being retained by the lip body forward portion, the inner edge having a slot therein at least partially therearound, the slotted inner edge slidable over the lip body beveled forward edge;
an arcuate front edge; and
opposed back ends in bridging relation between the front and the inner edges, the back ends dimensioned to substantially coincide with the lip body shoulders, the front edge meeting the lip body forward portion edge to form a substantially continuous side edge.

10. The variable-depth fishing lure recited in claim 1, wherein the lip extension comprises a moldable plastic material having a hardness less than a hardness of the lip body for facilitating a press fit therebetween.

11. A fishing lure kit comprising:
a fishing lure comprising:
an elongated lure body; and
a depth-control lip body extending from a front end of the lure body, the lip body having:
opposed sides substantially parallel to opposed sides of the lure body; and
an arcuate forward portion meeting the opposed sides at outwardly extending shoulders, the forward portion having a beveled edge at least partially therearound; and
a plurality of lip extensions, each removably affixable to the lip body and each having:
an arcuate inner edge dimensioned for sliding onto and being retained by the lip body forward portion, the inner edge having a slot therein at least partially therearound, the slotted inner edge slidable over the lip body beveled forward edge;
an arcuate front edge; and
opposed back ends in bridging relation between the front and the inner edges, the back ends dimensioned to substantially coincide with the lip body shoulders, the front edge meeting the lip body forward portion edge to form a substantially continuous side edge.

12. A method of making a variable-depth fishing lure comprising:
producing an elongated lure body having a depth-control lip body extending from a front end thereof the lure body, the lip body having:
opposed sides substantially parallel to opposed sides of the lure body; and
an arcuate forward portion meeting the opposed sides at outwardly extending shoulders, the forward portion having a beveled edge at least partially therearound; and
producing a lip extension having:
an arcuate inner edge dimensioned for sliding onto and being retained by the lip body forward portion, the inner edge having a slot therein at least partially therearound, the slotted inner edge slidable over the lip body beveled forward edge;
an arcuate front edge; and
opposed back ends in bridging relation between the front and the inner edges, the back ends dimensioned to substantially coincide with the lip body shoulders, the front edge meeting the lip body forward portion edge to form a substantially continuous side edge.

13. The method recited in claim 12, wherein the lip extension producing step comprises producing a plurality of lip extensions, each having a different length along a longitudinal axis thereof, the lip extensions interchangeable for achieving different water depths.

14. The method recited in claim 12, wherein the lip extension producing step comprises molding the lip extension from a plastic material having a hardness less than a hardness of the lip body for facilitating a press fit therebetween.

15. A method of fishing comprising:
affixing a fishing lure to a fishing line, the fishing lure comprising:
an elongated lure body;
a depth-control lip body extending from a front end of the lure body, the lip body having:
opposed sides substantially parallel to opposed sides of the lure body; and
an arcuate forward portion meeting the opposed sides at outwardly extending shoulders, the forward portion having a beveled edge at least partially therearound;
sliding a first lip extension onto the lip body, the first lip extension having:
an arcuate inner edge dimensioned for sliding onto and being retained by the lip body forward portion, the inner edge having a slot therein at least partially therearound, the slotted inner edge slidable over the lip body beveled forward edge;
an arcuate front edge; and
opposed back ends in bridging relation between the front and the inner edges, the back ends dimensioned to substantially coincide with the lip body shoulders, the front edge meeting the lip body forward portion edge to form a substantially continuous side edge;
casting the fishing lure into a body of water;
reeling in the fishing lure;
removing the first lip extension from the lip body; and
sliding a second lip extension onto the lip body, the second lip extension having:
an arcuate inner edge dimensioned for sliding onto and being retained by the lip body forward portion, the inner edge having a slot therein at least partially therearound, the slotted inner edge slidable over the lip body beveled forward edge;
an arcuate front edge; and
opposed back ends in bridging relation between the front and the inner edges, the back ends dimensioned to substantially coincide with the lip body shoulders, the front edge meeting the lip body forward portion edge to form a substantially continuous side edge.
